(19) United States
(12) Patent Application Publication
(10) Pub. No.: US 2024/0185325 A1
(43) Pub. Date: Jun. 6, 2024

(54) USER CATEGORIZATION AND INSIGHT METHODS AND SYSTEMS

(71) Applicant: Volvo Car Corporation, Göteborg (SE)

(72) Inventors: Douglas Robert Case, Saratoga, CA (US); Orhan Uyaver, Gothenburg (SE); Qirui Li, Bayonne, NJ (US); Sai Krishna Ravilisetty, Cupertino, CA (US); Shabana Firdose, Sunnyvale, CA (US)

(21) Appl. No.: 18/529,056

(22) Filed: Dec. 5, 2023

Related U.S. Application Data
(60) Provisional application No. 63/430,371, filed on Dec. 6, 2022.

(51) Int. Cl. G06Q 30/0601

(52) U.S. Cl. CPC G06Q 30/0633

(57) ABSTRACT

Methods and systems for characterizing a user or a session associated with a user interface and customizing the user interface responsive to the characterization such that a sales transaction is facilitated. The methods and systems are applicable in the vehicle sales, leasing, subscription, and rental contexts, as well as in other contexts.

### CROSS-REFERENCE TO RELATED APPLICATION

The present disclosure claims the benefit of priority of co-pending U.S. Provisional Patent Application No. 63/430,371, filed on Dec. 6, 2022, and entitled “USER CATEGORIZATION AND INSIGHT METHODS AND SYSTEMS,” the contents of which are incorporated in full by reference herein.

### TECHNICAL FIELD

The present disclosure relates generally to user categorization and insight methods and systems.

### BACKGROUND

Today, in vehicle sales, leasing, subscription, and rental user interfaces (UIs), users will often start an order, and then abandon it. That is, they will pick a car they like, fill in their User Details in the UI, but then not proceed further with the order (also known as abandonment, or abandoned orders). Their personal details include things like name, phone number, email address, address, etc. An Inside Sales team will then take these partially filled-out orders and contact the customers to try to sell them a car. The Inside Sales team makes some limited attempts to correlate these new abandoned orders with previous orders (fulfilled or abandoned), but it is generally done manually and is very inexact, inefficient, and incomplete.

The present background is provided as context only and should not be construed to be limiting in any manner. It will be readily apparent to those of ordinary skill in the art that the principles and concepts of the present disclosure may be implemented in other contexts equally, with limitation.

### SUMMARY

In vehicle sales, leasing, subscription, and rental, the present disclosure provides for the query of old/incomplete orders based on name/phone number/email, as well as the creation of a PDF file or the like including a new order combined with the pre-existing orders that match the query. The PDF or the like is stored in an order manager, so that it could be made available to the Inside Sales team and other internal teams via a UI. In this manner, a new UI is generated based on parsed information that has not been gathered before.

In one illustrative embodiment, the present disclosure provides an automated user categorization and insight method, including: using a user identification algorithm stored in a memory and executed by a processor, identifying a user or device and capturing information associated with a failed or incomplete transaction to purchase a product via an external user interface; using a correlation algorithm stored in the memory and executed by the processor, associating the failed or incomplete transaction to purchase the product with a successful or completed transaction to purchase the product and determine a degree of association; and, using an order manager stored in the memory and executed by the processor, generating an internal user interface providing a list of failed or incomplete transactions to purchase the product including the identified user or device and the captured information associated with the failed or incomplete transaction to purchase the product and visually indicating the determined degree of association. The automated user categorization and insight method further includes, using the order manager, establishing a communication link between the order manager and an external sales device if the determined degree of association exceeds a predetermined threshold. The automated user categorization and insight method further includes, using the order manager, establishing a communication link between the order manager and an external user device if the determined degree of association exceeds a predetermined threshold. The degree of association is based on one or more of name, family name, device identification, email address, phone number, address, and geographic location. The degree of association is based on one or more of financial information, similar product selections, similar configurator preferences, similar configurator usage order and speed, and similar indications of desired delivery date. The order manager is further configured to monitor the successful closure of secondary transactions and provide feedback to the correlation algorithm to assess a degree of association of future failed or incomplete transactions to purchase the product with future successful or completed transactions to purchase the product. The automated user categorization and insight further includes, using the order manager, visually indicating preferenced failed or incomplete transactions to purchase the product based on a determined likelihood for transaction closure related to a predetermined product offering.

In another illustrative embodiment, the present disclosure provides a non-transitory computer readable medium including instructions stored in a memory and executed by a processor to carry out steps including: using a user identification algorithm, identifying a user or device and capturing information associated with a failed or incomplete transaction to purchase a product via an external user interface; using a correlation algorithm, associating the failed or incomplete transaction to purchase the product with a successful or completed transaction to purchase the product and determine a degree of association; and, using an order manager, generating an internal user interface providing a list of failed or incomplete transactions to purchase the product including the identified user or device and the captured information associated with the failed or incomplete transaction to purchase the product and visually indicating the determined degree of association. The steps further include, using the order manager, establishing a communication link between the order manager and an external sales device if the determined degree of association exceeds a predetermined threshold. The steps further include, using the order manager, establishing a communication link between the order manager and an external user device if the determined degree of association exceeds a predetermined threshold. The degree of association is based on one or more of name, family name, device identification, email address, phone number, address, and geographic location. The degree of association is based on one or more of financial information, similar product selections, similar configurator preferences, similar configurator usage order and speed, and similar indications of desired delivery date. The order manager is further configured to monitor the successful closure of secondary transactions and provide feedback to the correlation algorithm to assess a degree of association of future failed or incomplete transactions to purchase the product with future successful or completed transactions to purchase the product. The steps further including, using the order manager, visually indicating preferenced failed or incomplete transactions to purchase the product based on a determined likelihood for transaction closure related to a predetermined product offering.

In a further illustrative embodiment, the present disclosure provides an automated user categorization and insight system, including: a user identification algorithm stored in a memory and executed by a processor and configured to identify a user or device and capturing information associated with a failed or incomplete transaction to purchase a product via an external user interface; a correlation algorithm stored in the memory and executed by the processor and configured to associate the failed or incomplete transaction to purchase the product with a successful or completed transaction to purchase the product and determine a degree of association; and an order manager stored in the memory and executed by the processor and configured to generate an internal user interface providing a list of failed or incomplete transactions to purchase the product including the identified user or device and the captured information associated with the failed or incomplete transaction to purchase the product and visually indicating the determined degree of association. The order manager is further configured to establish a communication link between the order manager and an external sales device if the determined degree of association exceeds a predetermined threshold. The order manager is further configured to establish a communication link between the order manager and an external user device if the determined degree of association exceeds a predetermined threshold. The degree of association is based on one or more of name, family name, device identification, email address, phone number, address, and geographic location. The degree of association is based on one or more of financial information, similar product selections, similar configurator preferences, similar configurator usage order and speed, and similar indications of desired delivery date. The order manager is further configured to monitor the successful closure of secondary transactions and provide feedback to the correlation algorithm to assess a degree of association of future failed or incomplete transactions to purchase the product with future successful or completed transactions to purchase the product.

### BRIEF DESCRIPTION OF THE DRAWINGS

The present disclosure is illustrated and described herein with reference to the various drawings, in which:

FIG. 1 is an architectural diagram illustrating the above described sales scenario;

FIG. 2 is a network diagram of a cloud-based system for implementing the various algorithms and services of the present disclosure;

FIG. 3 is a block diagram of a server that may be used in the cloud-based system of FIG. 2 or stand-alone; and

FIG. 4 is a block diagram of a user device that may be used in the cloud-based system of FIG. 2 or stand-alone.

### DESCRIPTION

Today, most UIs do not categorize users/customers at all. Categorization of users/customers is an old and well-understood idea. However, data can be leveraged differently to create more value for internal and external users. Benefits can be provided to an Inside Sales team if an order is abandoned early in the cycle of filling out the UI to lease or buy a car, for example. That is when the Inside Sales team gets involved and contacts the customers directly, in what has been very manual process to date.

The present disclosure can provide benefits to a credit/risk underwriter team when they must manually determine if a customer is credit-worthy, or when there is a need to determine if they really know the identity of a customer.

The present disclosure can provide benefits to a vehicle manufacturer by maximizing sales, maximizing profits, and improving customer satisfaction. Optimizing/maximizing sales and profits based on user categorization and user choices is a known idea. The present disclosure extends this to also optimize environmental impact, customer satisfaction, and vehicle safety based on user categorization (including user location).

This is not market-specific, and could be generally applied across different markets/countries.

The present solution can store information about an order and other related orders in a PDF file or the like, hosted in the cloud, and used to assemble a present a new UI. While this is in some ways a low-tech approach, this can have advantages for the Inside Sales team since some of those team members are not highly technical and might be more comfortable with one all-in-one file and automatically-generated UI than with having to navigate data that is in a database of some type. These PDFs or the like can automatically age out to prevent taking too much space, to prevent storing PII data beyond some GDPR-related time limits, and to prevent them from becoming irrelevant. Data for a customer could also be stored in a database as well. Although a PDF file is mentioned, this is one example, and a database record, an email, a text file, an ERP system entry, and/or analytics data could be substituted for the PDF file.

By querying previous orders based on the user's name, email address, and phone number, one can determine if this is a duplicate order, and take appropriate action based on that.

Users can be categorized based on their personal details (name, address, postal code, date of birth) and sometimes including information about their income. They can also be categorized based on what exact choices they have made for the vehicle they are ordering with this order. They can also be categorized based on previous orders for vehicle(s).

Users' IP address and/or browser and/or host machine type (Windows or Mac) can be used for categorization as well.

Users can also be categorized based on the status of previous orders. For example, if a customer has had multiple vehicle orders previously that were sold/fulfilled that makes them a very good prospect for the Inside Sales team to engage and try to sell to. But if a customer has repeatedly abandoned or cancelled previous orders that makes them very low priority for the Inside Sales team to engage. If there are previous orders at the same address or email or phone, but with the same last name but a different first name that makes it likely that a family member has made these orders. That can be very helpful to the Inside Sales team. Information is power and having a lot of information like this can help the Inside Sales team to engage customers more knowledgably and even ask customers about previous orders. This information can give the Inside Sales team the ability to prioritize/rank the customers in terms of leads. For example, the top priority customers might be contacted first or contacted by the top salesperson. The Inside Sales team might not contact some customers at all if they are of low priority.

The present disclosure can categorize based not only upon an individual, but by presumed family members if one is not sure if one has information about the individual. For example, if one has no data on previous orders for the same name, but if one has previous orders that are associated with the same email, phone, address, and/or IP address then use that for categorization. Even if it might be a family member but not the same individual, that categorization is still presumed to be helpful and predictive. Further, one could determine by address if a neighbor has purchased a particular vehicle, and if so exactly what kind of vehicle, and then utilize this knowledge for a given transaction, as it may or may not affect consumer behavior. Further, a “people who bought this item also tend to buy x or y or z” approach could be utilized, saying something like “several people in your area have bought model x,” for example.

The present disclosure can categorize, for example, based on Luxury—whether the customer orders custom rims, extra cameras, leather, and/or other pricy add-ons and/or based on the user going for the high-priced models.

Today a significant minority of customers get electric vehicles (EVs). Vehicle manufacturers would love to increase the amount of EV's that are sold for many reasons, including helping the environment, getting an even better reputation, better profitability, etc. But today most customers do not want an EV. So, if the EVs are “pushed” too much in a UI or in Inside Sales communications it would be counter-productive and annoy users and reduce sales. But, as part of the categorization, one could assess how likely a user is to want to get an EV, based on many factors including: have they or a family member ordered an EV before, have they looked at EVs in the UI, and have they looked at any EV-related options or accessories in the UI. This could be a separate kind of categorization beyond whether the user is interested in luxury, or economy, etc. This could factor in a user's age, income, address/zip code, etc. This could even factor in location-related information such as for their location and if there a lot of chargers available. This could also factor in how popular EVs are in general for that location. There could be a categorization for how interested one thinks the user is in EVs, and a related score for how confident one is in that assessment (for example the confidence level would be higher if one knew they had spent a lot of time looking at EVs rather than just if based on their income and address one thought they might be a decent candidate for EVs).

Based on categorization, one could also consider selling add-ons, or not.

One key factor in customer satisfaction is how long a customer has to wait for the car to be built/delivered. This can often take several months. To increase customer satisfaction, one can “steer” them toward cars that are currently available, or at least car models/etc. that one knows could be built relatively quickly. To “steer” a customer to a specific car model or trim, one can make that model and trim as the top/default selection in a dropdown list, or at least make it very high in the order of things in the dropdown list. One can also make it more prominent in a display of images of car models. On a related note, one could also explicitly recommend the soonest available car. That is, in addition to or instead of positioning a certain car more prominently in the UI, one could explicitly inform the user about the implications of one model or feature of a car compared to another. One example is if there is a worldwide shortage of yellow paint and a big supply of red paint, one could explicitly inform the user something like: “If you want the yellow car it'll take two months, but if you get a red car it'll take two weeks.” In order to do this, one could actually have a recommendation engine that factors in what are the materials needed, the materials available, and the materials already allocated for other existing car orders that have not been built yet.

Thus, the method and system can be predictive—based on categorizations.

The UI can be customized—car, and HOW it is displayed, even color. Order within dropdowns can be controlled. Order of EV can be customized based on many factors—to try to push EVs when appropriate. All options may be shown (for consistency—allow all users access to same vehicle), but involve defaulting/ordering dropdowns differently, and showing car images designed to appeal to that category of customer.

One could consider what categorizations of users give the highest customer satisfaction rating to which kinds of cars and try to “steer” customers to those.

Categorization may be based on patience, AND how long until the car arrives (which also affects customer satisfaction).

One could give a family discount as well based in these ideas.

In order to protect PII/GDPR/anonymity, when one categorizes a customer, one could send data “back” to the vehicle manufacturer correlating the car that is ordered with the user's zip code/location/income/etc. This could be sent back to the manufacturer without any PII (Personally identifiable information). This could be stored as part of a database to help categorize future users using an artificial intelligence (AI) algorithm or the like.

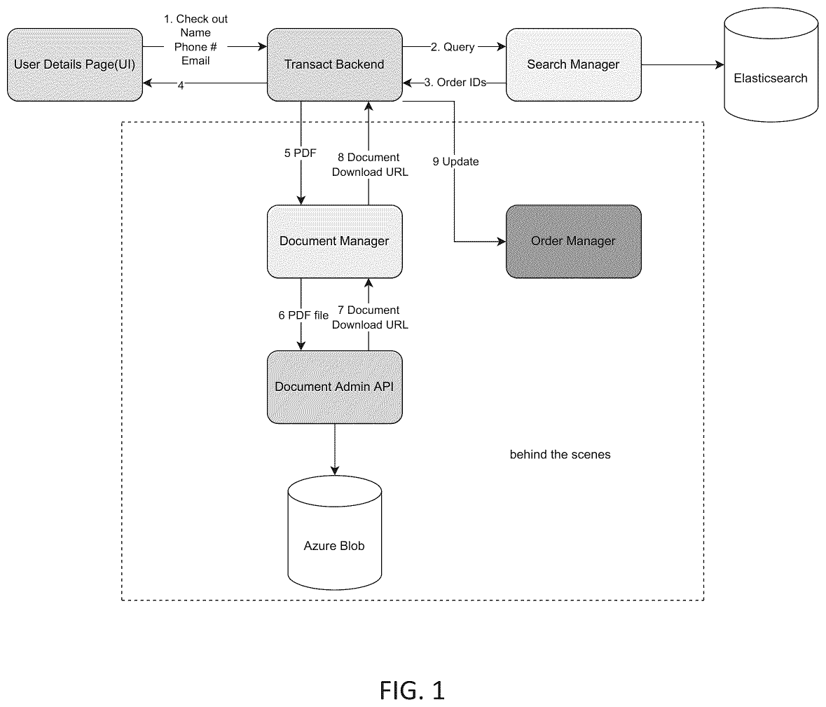

FIG. 1 is an architectural diagram illustrating this scenario, as well as some of the concepts of the present disclosure. One part that is attributable to the present disclosure is the query of old orders based on name/phone number/email (#1/#2/#3), as well as the creation of a PDF file or the like including the new order combined with the pre-existing orders that match the query (#5/#6/#7/#8). #9 shows storing the PDF or the like in an order manager, so that it could be made available to the Inside Sales team and other internal teams via a UI.

As illustrated in FIG. 1, the system at #1 includes a user ID algorithm that identifies a user associated with a failed or incomplete transaction, as well as any available vehicle configuration details, for example. Such user ID algorithm may be correlated and compared with any other failed or incomplete transactions. The system at #2 includes a user correlation algorithm that, with or in the absence of an appropriate user ID, correlates any available information with other successful or completed transactions, such as at the same email address, address, geographical location, using the same financial information, and/or using other common information. Thus, the system at #1, #2, and #3 correlates a failed or incomplete transaction with known successful or completed transactions, assessing a degree of relatedness. For example, an incomplete transaction by an individual may be considered very closely related to a completed transaction by the same individual. An incomplete transaction by an individual may be considered reasonably closely related to a completed transaction by a related individual with the same name in the same family. An incomplete transaction by an individual may be considered somewhat closely related to a completed transaction by a neighboring individual with a similar address. An incomplete transaction by an individual may be considered somewhat related to a completed transaction by an individual in the same geographic area. The closeness of other characteristics may also be used to rate the likelihood that an incomplete transaction may result in a later completed transaction, such as similar financial information, similar product selections, similar configurator preferences, similar configurator usage order and speed, similar indications of desired delivery date, etc. At system #4, #5, and #6,the system automatically generates an inside UI that provides the details of selected incomplete transactions, assigning them an order of priority based on the foregoing factors. This priority may be indicated by visual cues provided on the inside UI. Further, high priority items may trigger system generated alerts to members of an Inside Sales Team via text, email, etc. at system #7, #8, and #9. Finally, at system #9, the successful closure of secondary transactions may be monitored to provide AI feedback or the like to the prioritization algorithm used to rank and present failed transactions, with manual tweaks to the algorithm also being possible.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

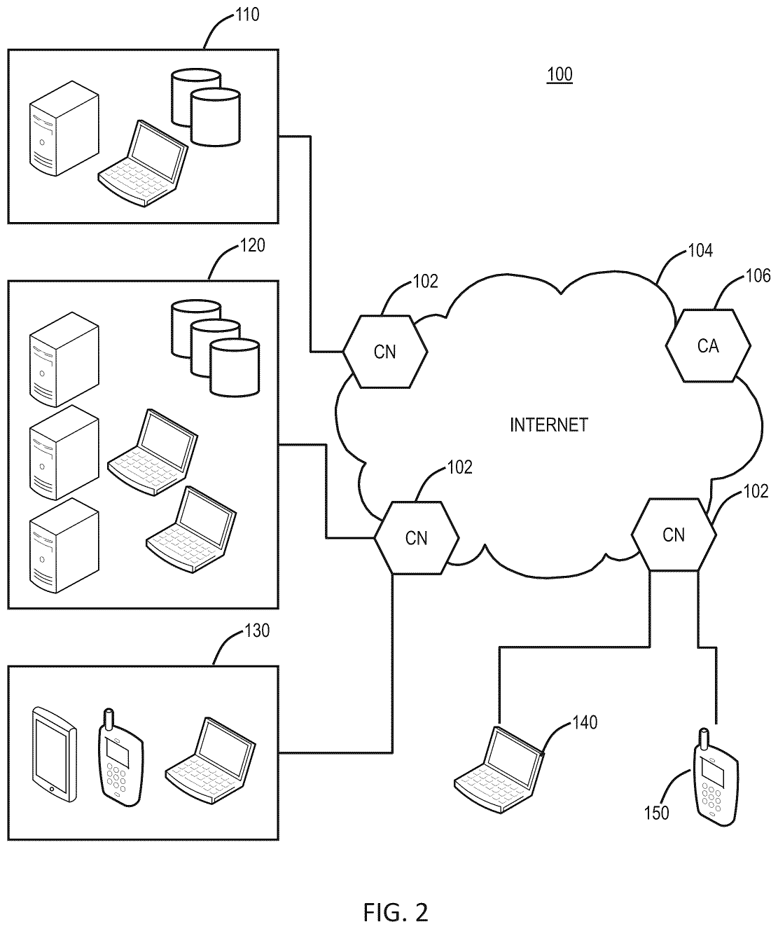

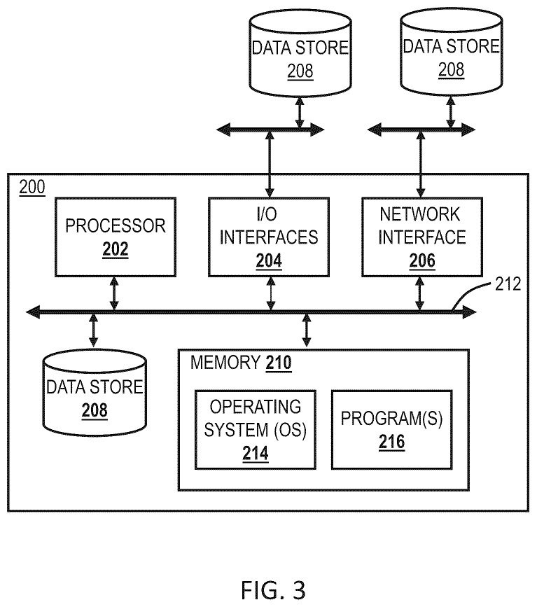

FIG. 2 is a network diagram of a cloud-based system 100 for implementing various cloud-based services of the present disclosure. The cloud-based system 100 includes one or more cloud nodes (CNs) 102 communicatively coupled to the Internet 104 or the like. The cloud nodes 102 may be implemented as a server 200 (as illustrated in FIG. 3) or the like and can be geographically diverse from one another, such as located at various data centers around the country or globe. Further, the cloud-based system 100 can include one or more central authority (CA) nodes 106, which similarly can be implemented as the server 200 and be connected to the CNs 102. For illustration purposes, the cloud-based system 100 can connect to a regional office 110, headquarters 120, various employee's homes 130, laptops/desktops 140, and mobile devices 150, each of which can be communicatively coupled to one of the CNs 102. These locations 110, 120, and 130, and devices 140 and 150 are shown for illustrative purposes, and those skilled in the art will recognize there are various access scenarios to the cloud-based system 100, all of which are contemplated herein. The devices 140 and 150 can be so-called road warriors, i.e., users off-site, on-the-road, etc. The cloud-based system 100 can be a private cloud, a public cloud, a combination of a private cloud and a public cloud (hybrid cloud), or the like.

Again, the cloud-based system 100 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 110, 120, and 130 and devices 140 and 150. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 100 is illustrated herein as one example embodiment of a cloud-based system, and those of ordinary skill in the art will recognize the systems and methods described herein are not necessarily limited thereby.

FIG. 3 is a block diagram of a server 200, which may be used in the cloud-based system 100 (FIG. 2), in other systems, or stand-alone. For example, the CNs 102 (FIG. 2) and the central authority nodes 106 (FIG. 2) may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but is not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104 (FIG. 2). The network interface 206 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., a SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

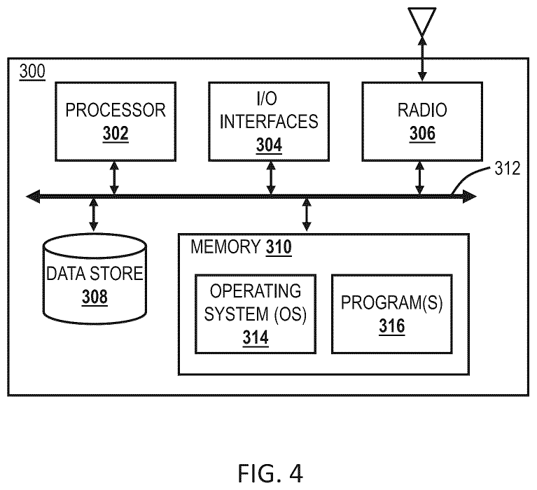

FIG. 4 is a block diagram of a user device 300, which may be used in the cloud-based system 100 (FIG. 2), as part of a network, or stand-alone. Again, the user device 300 can be a vehicle, a smartphone, a tablet, a smartwatch, an Internet of Things (IOT) device, a laptop, a virtual reality (VR) headset, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 3 depicts the user device 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example, but is not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, the memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 4, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network, such as the cloud-based system 100 (FIG. 2).

Again, the present disclosure provides a system and method for removing noise from an ultrasonic signal using a GAN. GANs have been shown to perform well in removing noise from images in a variety of contexts, providing sharper images. In general, a GAN is a DNN, such as a CNN, that, in an unsupervised ML operation, involves automatically discovering and learning patterns in input data such that the resulting model can be used to generate output that plausibly could have been resulted from the original dataset. The GAN frames a problem as a supervised learning problem with two sub-models: a generator model that generates new examples and a discriminator model that classifies examples as either real (i.e., from the domain) or fake (i.e., generated). The two models are trained together in an adversarial manner until the discriminator model is fooled about half the time, meaning the generator model is generating plausible examples. Such GANs are well known to those of ordinary skill in the art, but have not yet been applied to ultrasonic sensor noise removal. The present disclosure provides three input formats for the NN in order to feed 1D input data to the network. The system is generalizable to multiple noise sources, as it learns from different motion functions and noise types. The end-to-end system of the present disclosure is trained on raw ultrasonic signals with very little pre-processing or feature extraction.

Other functionalities contemplated herein include monitoring where on a page a user clicks as well as their click speed to try to characterize the user for subsequent vehicle preferencing. Gaze direction on a page can also be monitored and utilized using a camera in a vehicle or virtual reality (VR)-based system, or even a mobile device-based system. A multitude of similar other factors may be considered as well.

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. An automated user categorization and insight method, comprising:
using a user identification algorithm stored in a memory and executed by a processor, identifying a user or device and capturing information associated with a failed or incomplete transaction to purchase a product via an external user interface;
using a correlation algorithm stored in the memory and executed by the processor, associating the failed or incomplete transaction to purchase the product with a successful or completed transaction to purchase the product and determine a degree of association; and
using an order manager stored in the memory and executed by the processor, generating an internal user interface providing a list of failed or incomplete transactions to purchase the product including the identified user or device and the captured information associated with the failed or incomplete transaction to purchase the product and visually indicating the determined degree of association.

2. The automated user categorization and insight method of claim 1, further comprising, using the order manager, establishing a communication link between the order manager and an external sales device if the determined degree of association exceeds a predetermined threshold.

3. The automated user categorization and insight method of claim 1, further comprising, using the order manager, establishing a communication link between the order manager and an external user device if the determined degree of association exceeds a predetermined threshold.

4. The automated user categorization and insight method of claim 1, wherein the degree of association is based on one or more of name, family name, device identification, email address, phone number, address, and geographic location.

5. The automated user categorization and insight method of claim 1, wherein the degree of association is based on one or more of financial information, similar product selections, similar configurator preferences, similar configurator usage order and speed, and similar indications of desired delivery date.

6. The automated user categorization and insight method of claim 1, wherein the order manager is further configured to monitor the successful closure of secondary transactions and provide feedback to the correlation algorithm to assess a degree of association of future failed or incomplete transactions to purchase the product with future successful or completed transactions to purchase the product.

7. The automated user categorization and insight method of claim 1, further comprising, using the order manager, visually indicating preferenced failed or incomplete transactions to purchase the product based on a determined likelihood for transaction closure related to a predetermined product offering.

8. A non-transitory computer readable medium comprising instructions stored in a memory and executed by a processor to carry out steps comprising:
using a user identification algorithm, identifying a user or device and capturing information associated with a failed or incomplete transaction to purchase a product via an external user interface;
using a correlation algorithm, associating the failed or incomplete transaction to purchase the product with a successful or completed transaction to purchase the product and determine a degree of association; and
using an order manager, generating an internal user interface providing a list of failed or incomplete transactions to purchase the product including the identified user or device and the captured information associated with the failed or incomplete transaction to purchase the product and visually indicating the determined degree of association.

9. The non-transitory computer readable medium of claim 8, the steps further comprising, using the order manager, establishing a communication link between the order manager and an external sales device if the determined degree of association exceeds a predetermined threshold.

10. The non-transitory computer readable medium of claim 8, the steps further comprising, using the order manager, establishing a communication link between the order manager and an external user device if the determined degree of association exceeds a predetermined threshold.

11. The non-transitory computer readable medium of claim 8, wherein the degree of association is based on one or more of name, family name, device identification, email address, phone number, address, and geographic location.

12. The non-transitory computer readable medium of claim 8, wherein the degree of association is based on one or more of financial information, similar product selections, similar configurator preferences, similar configurator usage order and speed, and similar indications of desired delivery date.

13. The non-transitory computer readable medium of claim 8, wherein the order manager is further configured to monitor the successful closure of secondary transactions and provide feedback to the correlation algorithm to assess a degree of association of future failed or incomplete transactions to purchase the product with future successful or completed transactions to purchase the product.

14. The non-transitory computer readable medium of claim 8, the steps further comprising, using the order manager, visually indicating preferenced failed or incomplete transactions to purchase the product based on a determined likelihood for transaction closure related to a predetermined product offering.

15. An automated user categorization and insight system, comprising:
a user identification algorithm stored in a memory and executed by a processor and configured to identify a user or device and capturing information associated with a failed or incomplete transaction to purchase a product via an external user interface;
a correlation algorithm stored in the memory and executed by the processor and configured to associate the failed or incomplete transaction to purchase the product with a successful or completed transaction to purchase the product and determine a degree of association; and
an order manager stored in the memory and executed by the processor and configured to generate an internal user interface providing a list of failed or incomplete transactions to purchase the product including the identified user or device and the captured information associated with the failed or incomplete transaction to purchase the product and visually indicating the determined degree of association.

16. The automated user categorization and insight system of claim 15, wherein the order manager is further configured to establish a communication link between the order manager and an external sales device if the determined degree of association exceeds a predetermined threshold.

17. The automated user categorization and insight system of claim 15, wherein the order manager is further configured to establish a communication link between the order manager and an external user device if the determined degree of association exceeds a predetermined threshold.

18. The automated user categorization and insight system of claim 15, wherein the degree of association is based on one or more of name, family name, device identification, email address, phone number, address, and geographic location.

19. The automated user categorization and insight system of claim 15, wherein the degree of association is based on one or more of financial information, similar product selections, similar configurator preferences, similar configurator usage order and speed, and similar indications of desired delivery date.

20. The automated user categorization and insight system of claim 15, wherein the order manager is further configured to monitor the successful closure of secondary transactions and provide feedback to the correlation algorithm to assess a degree of association of future failed or incomplete transactions to purchase the product with future successful or completed transactions to purchase the product.
